(19) United States
(12) Patent Application Publication
(10) Pub. No.: US 2007/0147643 A1
(43) Pub. Date: Jun. 28, 2007

(54) Hearing aid module

(75) Inventor: Esfandiar Grafenberg, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/642,110

(22) Filed: Dec. 20, 2006

(30) Foreign Application Priority Data
Dec. 23, 2005 (DE) 10 2005 061 795.6

(51) Int. Cl. H04R 25/00

(52) U.S. Cl. 381/324; 381/322

(57) ABSTRACT

The aim of the invention is to further reduce the dimensions of hearing aids. Toward that end a hearing aid module is provided which can be mechanically and electrically attached by means of an electromechanical interface to a corresponding multipurpose interface of a hearing aid. At least one hearing aid control element or one display element is provided in the module. Alternatively or in addition, further electrical interfaces can also be attached to the module. This enables a very small basic hearing aid to be made available which can be extended as desired in terms of complexity and corresponding size.

### CROSS REFERENCE TO RELATED APPLICATIONS

This application claims priority of German application No. 10 2005 061 795.6 filed Dec. 23, 2005, which is incorporated by reference herein in its entirety

### FIELD OF THE INVENTION

The present invention relates to a hearing aid module for attaching to a hearing aid or some other hearing apparatus.

### BACKGROUND OF THE INVENTION

Hearing aid housings for behind-the-ear hearing aids as well as for in-the-ear hearing aids become correspondingly bigger as a result of control elements being installed. Control elements to be cited first and foremost in this connection are volume controls, program switches, on/off switches, and so forth.

A remote control which would enable control elements directly attached to the hearing aid to be dispensed with is not always suitable for ease-of-use reasons or not always desired by the hearing aid wearer. Reasons for this are on the one hand that it would then always be necessary to take along a remote control in order to operate the device, but this often does not happen due to forgetfulness. On the other hand, operating a hearing aid by means of a remote control can be rejected due to lack of time if, for example, a teacher of the hearing-impaired were to have to deal with the most disparate types of remote controls for hearing aids. Furthermore, a visible switch on the device is often desirable, particularly in the case of children, because it is then possible to tell immediately whether the device is switched on or off, for example.

Hearing aids are therefore offered with and without control elements in the marketplace. If space for a control element is provided on the hearing aid, interchangeable control elements are also offered in some cases. Said interchangeable control elements guarantee a certain degree of flexibility since they can be removed as necessary. A typical example of an interchangeable control element are removable volume controls. If the volume control is not required, the corresponding electrical interface is closed off by a panel. However, an interchangeable control element has the disadvantage that space must nonetheless be created in the hearing aid for the special interface.

The publication WO 00/79836 A1 discloses a behind-the-ear hearing aid having a surface-mounted module which is coupled mechanically and electrically to the hearing aid via an interface. This arrangement enables the hearing aid to be equipped with additional options, for example an interface unit for wireless signal transmission, a programming plug-in unit, a further audio input, a larger storage battery compartment, a mechanical activating unit, etc. In this way it is possible to expand the hearing aid in modular fashion in accordance with the wearer's wishes.

Furthermore, the patent publication EP 0 806 885 B1 describes a holding device for accessory components which can be mounted on a hearing aid. Said holding device has a second interface with at least two contacts disposed opposite one another and establishes a stable connection both mechanically and electrically.

The publication DE 298 19 993 U1 also discloses a hearing aid device with audio and/or programming interface. A reed switch is actuated by means of a permanent magnet integrated in an audio shoe when the shoe is connected to the hearing aid.

Moreover, the patent publication DE 102 28 828 C1 discloses a modular hearing aid device having a microphone module and a hearing aid device module. The two modules are detachably connected to each other.

### SUMMARY OF THE INVENTION

The object of the present invention is to further reduce the dimensions of a hearing aid.

This object is achieved according to the invention by means of a hearing aid module having an electromechanical interface for coupling both mechanically and electrically to a corresponding multipurpose interface of a hearing aid and at least one display element which can be connected via said interface to a hearing aid requiring connection. Optionally the hearing aid module can have at least one hearing aid control element.

The idea underlying the invention is to design a hearing aid according to the building block principle so that the size of the hearing aid can be adapted directly to suit the particular application.

An inventive hearing aid module having the at least one hearing aid control element and/or the display element preferably has in addition at least one further electrical interface as well as the electromechanical interface. In this way it is possible, for example, to equip a hearing aid module with the functionality of an audio shoe with additional control element such as, for example, a volume control.

However, the electrical interface or one of the electrical interfaces can also be a programming interface so that the hearing aid module has, for example, the functionality of a volume control and in addition of a programming interface.

According to another embodiment the electromechanical interface can be an audio shoe interface. This means that an audio connector could be plugged into the hearing aid without the need to use a hearing aid module. The hearing aid module is then plugged into the hearing aid by means of the contacts of a typical audio connection and additionally has the functionality of a control element, a display element or another interface.

For the purpose of mechanical attachment to the hearing aid, the electromechanical interface can additionally have a snap-on mechanism, a screw mechanism and/or a magnet. This allows the module to be conveniently attached to the hearing aid or, as the case may be, separated therefrom.

According to a further preferred embodiment the at least one hearing aid control element is a volume control, a lever switch (e.g. for switching on and off) and/or a pushbutton switch. The hearing aid module thus possesses the control function that is actually desired.

If a display element is provided in the hearing aid module, said display element can be embodied as a LED, as a single-digit display or as a multi-digit display. This allows, for example, information to be easily read out from the hearing aid.

### BRIEF DESCRIPTION OF THE DRAWINGS

The present invention will now be explained in more detail with reference to the accompanying drawings, in which:

FIG. 1 shows a schematic sketch of a behind-the-ear hearing aid with attached audio shoe module and

FIG. 2 shows a variant of the hearing aid module exclusively with on/off switch.

### DETAILED DESCRIPTION OF THE INVENTION

The exemplary embodiments described in more detail below represent preferred embodiments of the present invention.

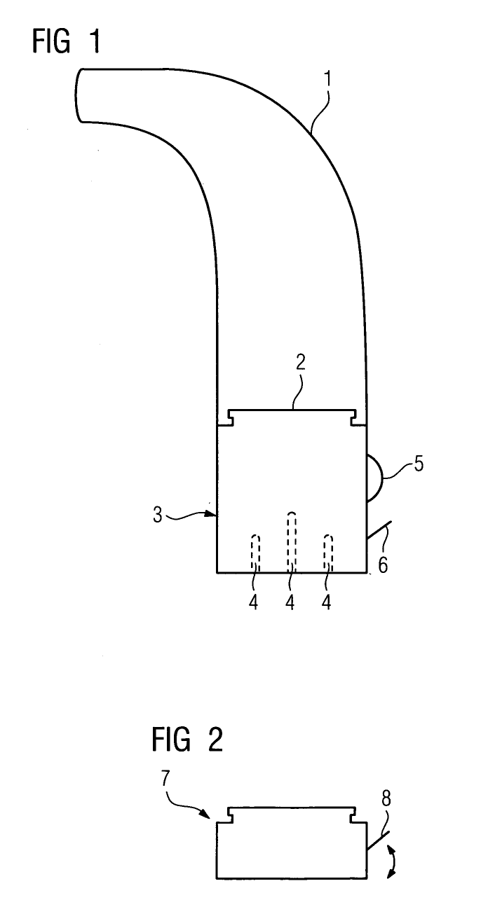

FIG. 1 is a schematic representation of a behind-the-ear hearing aid 1 (BTE hearing aid). Said BTE hearing aid 1 can be designated as a basic device; it has no control elements. At its lower end it is provided with an electromechanical interface 2. In the present case this is implemented in such a way that a hearing aid module 3 can be attached to the basic device 1 via a rail-like guide.

On the opposite side to the interface 2 the audio shoe module depicted in FIG. 1 has the typical audio contacts 4 of an audio shoe. The audio shoe module 3 is also provided with an on/off switch. In addition, the audio shoe module 3 has a volume control 6 which is likewise disposed on the side on which the on/off switch 5 is located. The audio shoe module 3 thus possesses a threefold functionality, which is to say that of an audio shoe, a switch and a volume control. The hearing aid wearer can therefore equip his or her basic device with precisely those functionalities that he or she personally requires.

Since the hearing aid can be expanded as desired with external modules according to the building block principle, the module 7 depicted in FIG. 2, for example, can also be attached to the interface 2 of the basic device 1. Said module 7 has only a volume control 8 and consequently is relatively small in its dimensions compared with the audio shoe module 3 illustrated in FIG. 1. The hearing aid wearer will prefer said module 7 if he or she does not need the functionality of an audio shoe and can also do without an on/off switch directly on the earpiece.

The mechanical attachment of the external module 3, 7 to the hearing aid 1 can also be realized by way of a snap-on or screw mechanism, or even magnetically. Whatever the case, it must be ensured by means of the mechanical attachment that the electrical contacts of the module reliably connect with the corresponding opposite contacts on the hearing aid.

The electrical contacts of the electromechanical interface 2 can be implemented in any desired form. It can, however, be particularly advantageous to use the contact geometry of an interface that is used very frequently on hearing aids. An interface geometry of this kind would be, for example, the geometry of a programming interface or an audio shoe.

The module itself can, as already indicated, contain a number of different functional units. Thus, other pushbuttons, for program selection for example, can also be provided in addition to the volume control 6, 8 and the on/off switch 5. Moreover, modules can also be provided which have a more or less complex display. To display purely binary information, e.g. on/off status, a LED with low power consumption is sufficient, for example. To display more extensive information, e.g. state of charge, program, etc., a single- or multi-digit LCD display or an equivalent display type can be used.

The external module can additionally be equipped with a charge adapter or a programming socket. Arbitrary combinations of the above-described control and display elements or, as the case may be, contact forwarding elements can also be accommodated in the module.

Thus, the user can advantageously order hearing aid control elements in any combination according to his or her wishes or needs and simply attach said elements to the basic hearing aid. The user for whom the compactness of the hearing aid is more important and for this reason prefers the remote control can enjoy the advantages of the small basic device.

The manufacturer also benefits from the modular design, since a basic device is developed as the basis and the additional preferences can be taken into account in separate modules, without the need to invest time, effort and resources in the development of a new device. As a result the complexity of hearing aids can be reduced to a minimum.

1.-8. (canceled)

9. A hearing aid module to be connected to a hearing aid device, comprising:
an electromechanical interface that couples the hearing aid module to a corresponding multipurpose interface of the hearing aid device; and
an element that is connected to the hearing aid device via the electromechanical interface.

10. The hearing aid module as claimed in claim 9, wherein the electromechanical interface is an audio shoe interface.

11. The hearing aid module as claimed in claim 9, further comprising an electrical interface.

12. The hearing aid module as claimed in claim 11, wherein the electrical interface is an audio shoe interface.

13. The hearing aid module as claimed in claim 11, wherein the electrical interface is a programming interface.

14. The hearing aid module as claimed in claim 9, wherein the hearing aid module is attached to the hearing aid device via the electromechanical interface by a method selected from the group consisting of: a snap-on mechanism, a screw mechanism, and a magnet.

15. The hearing aid module as claimed in claim 9, the element is a hearing aid control element or a display element.

16. The hearing aid module as claimed in claim 15, wherein the hearing aid control element is selected from the group consisting of: a volume control, an on/off switch, a pushbutton switch, and combinations thereof.

17. The hearing aid module as claimed in claim 15, wherein the display element is selected from the group consisting of: a LED, a single-digit display, and a multi-digit display.

18. A hearing aid device, comprising:
a base of the hearing aid device that does not comprise an element of the hearing aid device;
a hearing aid module that comprises the element of the hearing aid device; and
an interface that couples the hearing aid module to the base of the hearing aid device so that the element is connected to the hearing aid device.

19. The hearing aid device as claimed in claim 18, wherein the element is a hearing aid control element or a display element.

20. The hearing aid module as claimed in claim 19, wherein the hearing aid control element is selected from the group consisting of: a volume control, an on/off switch, a pushbutton switch, and combinations thereof.

21. The hearing aid module as claimed in claim 19, wherein the display element is selected from the group consisting of: a LED, a single-digit display, and a multi-digit display.
